(19) United States
(12) Patent Application Publication
(10) Pub. No.: US 2019/0244034 A1
(43) Pub. Date: Aug. 8, 2019

(54) METHODS AND APPARATUSES FOR PROCESSING VIDEO DATA

(71) Applicant: Shanghai Xiaoyi Technology Co., Ltd., Shanghai (CN)

(72) Inventor: Huayong Wang, Shanghai (CN)

(73) Assignee: Shanghai Xiaoyi Technology Co., Ltd., Shanghai (CN)

(21) Appl. No.: 16/266,615

(22) Filed: Feb. 4, 2019

(30) Foreign Application Priority Data
Feb. 6, 2018 (CN) 201810117924.8

(51) Int. Cl. G06K 9/00; G06F 17/18

(52) U.S. Cl. CPC G06K 9/00778; G06K 9/00248; G06F 17/18; G06K 9/00315; G06K 9/00342; G06K 9/00261

(57) ABSTRACT

A method and device for processing video data is provided. According to some embodiments, the method includes: recognizing at least one of a face or a piece of clothing from video data representing a scene; when the recognized face does not match a preset face or the recognized clothing does not match preset clothing, determining a user corresponding to the recognized face or recognized clothing to be a customer, the preset face or preset clothing corresponding to a greeter in the scene; performing a detection of at least one of facial expression, movement, or voice of the greeter from the video data, to generate a detection result; and determining a service quality of the greeter based on the detection result, to generate an assessment result.

### CROSS-REFERENCE TO RELATED APPLICATION

The disclosure claims the benefits of priority to Chinese Application No. 201810117924.8, filed on Feb. 6, 2018, which is incorporated herein by reference in its entirety.

### FIELD OF TECHNOLOGY

The exemplary embodiments of the present disclosure relate to the technical field of processing video data, and more particularly to a service quality monitoring method and device, and computer-readable storage medium and terminal thereof.

### BACKGROUND

In restaurants, hotels, and other businesses in the service sector, greeting or welcome service is typically provided when a customer enters through a door. The greeting service is provided by a greeter to the customer through a series of actions such as smiling and bowing, as well as verbal expressions such as “hello” and “welcome.”

The greeting service has a large impact on a customer's experience with a business and therefore it is important to ensure the quality of the greeting service is consistently kept at a high level. To achieve this goal, a business manager needs to continuously monitor and evaluate the performance of a greeter. Therefore, there is a pressing demand for a method and device to automatically monitor a greeting service.

### SUMMARY

The technical problem addressed by the exemplary embodiments of the present disclosure is how to collect and process video data, to efficiently detect and evaluate service quality.

In order to address the aforementioned technical problem, one exemplary embodiment of the present disclosure provides a method of processing video data, the method including: performing facial detection or clothing detection on acquired video data to obtain a face or clothing; when the face does not match a preset face or the clothing does not match a preset clothing, determining the user corresponding to the face to be a customer, the user corresponding to the preset face including a greeter, performing facial expression detection, movement detection, and/or voice detection on a greeter in the video data to obtain detection results; and evaluating service quality on the basis of the detection results to obtain an assessment result.

In some embodiments, the performing facial expression detection, movement detection, and/or voice detection on a greeter in the video data may include: detecting and acquiring a facial expression of the greeter, matching the facial expression against a preset expression to obtain an expression matching result, and adding the expression matching result to the detection results; and/or detecting and acquiring a movement performed by the greeter, matching the movement against a preset movement to obtain a movement matching result, and adding the movement matching result to the detection results; and/or detecting and acquiring a voice transcript of the greeter, matching the voice transcript against a preset transcript to obtain a voice matching result, and adding the voice matching result to the detection results.

In some embodiments, the evaluating service quality on the basis of the detection results may include: on the basis of the expression matching result, the movement matching result, and/or the voice matching result in the detection results of each greeter, determining the service quality of each greeter and adding the service quality to the assessment result.

In some embodiments, the method of processing video data may further include: concluding a monitoring session when, in the video data, the customer is detected to have left.

In some embodiments, the method of monitoring service quality may further include: recording the start time and end time of video data corresponding to each monitoring session, the start time being the moment when the user corresponding to the face is determined to be a customer, and the end time being the moment when the customer is detected to have left; and linking the assessment result of each monitoring session to the video data corresponding to each monitoring session.

In some embodiments, the method of processing video data may further include: performing statistics on the number of service sessions, the service time, and the service quality of each greeter on the basis of the video data corresponding to each monitoring session and the assessment result linked thereto to render statistical results; and performing an attendance evaluation on each greeter on the basis of the statistical results.

In order to address the aforementioned technical problem, one exemplary embodiment of the present disclosure further discloses a device for processing video data, the device including: an initial detection module adapted to perform facial detection or clothing detection on acquired video data to obtain a face or clothing; a user determination module adapted to, when the face does not match a preset face or the clothing does not match a preset clothing, determine the user corresponding to the face to be a customer, the user corresponding to the preset face including a greeter; a content detection module adapted to perform facial expression detection, movement detection, and/or voice detection on a greeter in the video data to obtain detection results; and an evaluation module adapted to evaluate service quality on the basis of the detection results to obtain an assessment result.

In some embodiments, the content detection module may include: a facial expression detection unit adapted to detect and acquire a facial expression of the greeter, match the facial expression against a preset expression to obtain an expression matching result, and add the expression matching result to the detection results; a movement performance detection unit adapted to detect and acquire a movement performed by the greeter, match the movement against a preset movement to obtain a movement matching result, and add the movement matching result to the detection results; and a voice detection unit adapted to detect and acquire a voice transcript of the greeter, match the voice transcript against a preset transcript to obtain a voice matching result, and add the voice matching result to the detection results.

In some embodiments, the evaluation module may include: a service quality evaluation unit adapted to, on the basis of the expression matching result, the movement matching result, and/or the voice matching result in the detection results of each greeter, determine the service quality of each greeter and add the service quality to the assessment result.

In some embodiments, the device for processing video data may further include: a monitoring conclusion determination module adapted to conclude a monitoring session when, in said video data, the customer is detected to have left.

In some embodiments, the device for processing video data may further include: a monitoring recording module adapted to record the start time and end time of video data corresponding to each monitoring session, the start time being the moment when the user corresponding to the face is determined to be a customer, and the end time being the moment when the customer is detected to have left; and a linking module adapted to link the assessment result of each monitoring session to the video data corresponding to each monitoring session.

In some embodiments, the device for processing video data may further include: a statistic module adapted to perform statistics on the number of service sessions, the service time, and the service quality of each greeter on the basis of the video data corresponding to each monitoring session and the assessment result linked thereto to render statistical results; and an attendance evaluation module adapted to perform an attendance evaluation on each greeter on the basis of the statistical results.

One exemplary embodiment of the present disclosure further discloses a non-transitory computer-readable medium comprising instructions that, when executed by a processor, cause the processor to perform the aforementioned method of processing video data being executed when the computer instruction is run.

One exemplary embodiment of the present invention further discloses a terminal comprising a storage device storing instructions that, when executed by a processor, cause the processor to perform the steps of the aforementioned method of processing video data.

In comparison with currently available technology, the technical solution provided by exemplary embodiments of the present disclosure has the following benefits.

The technical solution provided by the exemplary embodiments of the present disclosure performs facial detection or clothing detection on acquired video data to obtain a face or clothing; determines, when the face does not match a preset face or the clothing does not match a preset clothing, the user corresponding to the face to be a customer, the user corresponding to the preset face including a greeter; performs facial expression detection, movement detection, and/or voice detection on a greeter in the video data to obtain detection results; and evaluates service quality on the basis of the detection results to obtain an assessment result. The technical solution provided by the exemplary embodiments of the present disclosure determines the customer and greeter on the basis of the face or clothing in the video data; performs detection on the facial expression, movement, and/or voice of the greeter when the customer appears; and evaluates the service quality of the greeter on the basis of the detection results. This eliminates the subjectivity and labor costs associated with providing human judgment, achieves accuracy of service quality monitoring, and reduces monitoring costs, thereby increasing monitoring efficiency. Moreover, detection is not performed on the facial expression, movement, and/or voice of the greeter until a customer has been detected in the video data, preventing ineffective detection when no customer is present and reducing the power consumption of the detection device.

Further, the technical solution provided by the exemplary embodiments of the present disclosure records the start time and end time of video data corresponding to each monitoring session, the start time being the moment when the user corresponding to the face is determined to be a customer, and the end time being the moment when the customer is detected to have left; and links the assessment result of each monitoring session to the video data corresponding to each monitoring session. By determining and recording the start time and end time of each monitoring session and then linking its corresponding video data to its corresponding assessment result, the technical solution provided by the exemplary embodiments of the present disclosure achieves traceability and verifiability of the assessment result, thereby improving user experience.

Further, the technical solution provided by the exemplary embodiments of the present disclosure performs statistics on the number of service sessions, the service time, and the service quality of each greeter on the basis of the video data corresponding to each monitoring session and the assessment result linked thereto to render statistical results; and performs an attendance evaluation on each greeter on the basis of the statistical results. The technical solution provided by the exemplary embodiments of the present disclosure may further perform an attendance evaluation on a greeter using video data corresponding to the monitoring sessions, i.e. a service quality evaluation and an attendance evaluation are simultaneously achieved to increase monitoring efficiency.

### BRIEF DESCRIPTION OF DRAWINGS

FIG. 1 is a flowchart illustrating a method of processing video data, in accordance with an exemplary embodiment of the present disclosure;

FIG. 2 is a schematic diagram illustrating an exemplary application scenario, in accordance with an exemplary embodiment of the present disclosure;

FIG. 3 is a partial flowchart illustrating a method of processing video data, in accordance with an exemplary embodiment of the present disclosure;

FIG. 4 is a block diagram illustrating a device for processing video data, in accordance with an exemplary embodiment of the present disclosure;

FIG. 5 is a partial structural diagram illustrating a device for processing video data, in accordance with an exemplary embodiment of the present disclosure; and

FIG. 6 is a schematic diagram of a controller for processing video data, in accordance with an exemplary embodiment of the present disclosure.

### DETAILED DESCRIPTION OF INVENTION

As described above, there is currently a pressing demand for a method and device for automatically monitoring a greeting service. The present disclosure provides video processing methods and video processing devices to automatically monito the greeting service.

In order to make the aforementioned purposes, characteristics, and benefits of the exemplary embodiment of the present disclosure more evident and easier to understand, detailed descriptions of the exemplary embodiments of the present disclosure are provided below with reference to the drawings.

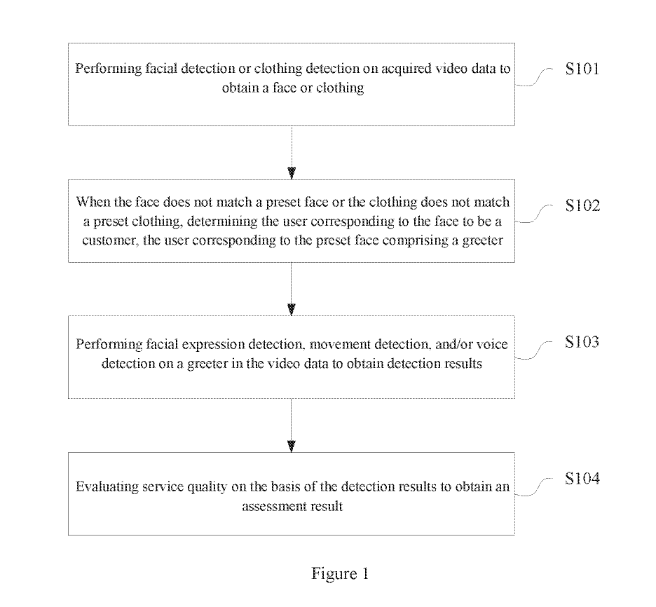

FIG. 1 is a flowchart illustrating a method of processing video data, in accordance with an exemplary embodiment of the present disclosure.

The method of processing video data illustrated in FIG. 1 may include the following steps:

Step S101: performing facial detection or clothing detection on acquired video data to obtain a face or clothing;

Step S102: when the face does not match a preset face or the clothing does not match a preset clothing, then determining the user corresponding to the face to be a customer, the user corresponding to the preset face including a greeter;

Step S103: performing facial expression detection, movement detection, and/or voice detection on a greeter in the video data to obtain detection results; and

Step S104: evaluating service quality on the basis of the detection results to obtain an assessment result.

In the present exemplary embodiment of the present disclosure, the method for of processing video data may be used on a video camera device. The video camera device may perform monitoring using video data that the video camera device obtains from recording. The method of processing video data may be used on any other terminal device that has computer capabilities.

The video data in the present exemplary embodiment of the present disclosure may be video recorded by the video camera device capturing a greeting area. The greeting area may be the entrance of a service site, for example, a restaurant doorway, a hotel doorway, etc.

In one exemplary embodiment, the video camera device may be installed and configured in any implementable location to ensure the picture recorded by the video camera device can cover the greeting area.

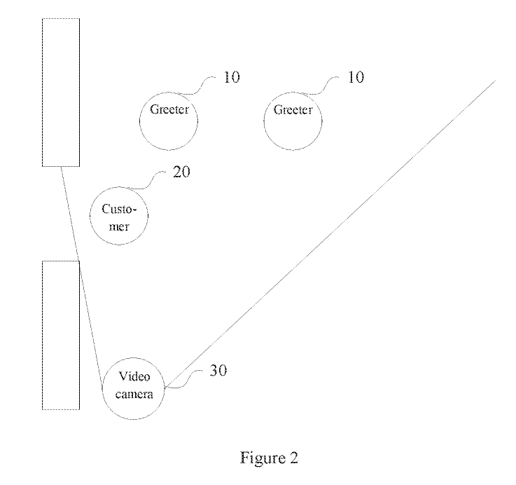

Referring to FIG. 2, in one exemplary application scenario, a video camera 30 may be installed at a fixed location near the doorway of a service site, and the angle range of the video camera 30 may cover the doorway and an effective service range. The video camera 30 may be powered and connected to a network, allowing the video camera to perform real-time monitoring. When a customer 20 and a greeter 10 appear in a monitoring range, the customer 20 and the greeter 10 may be monitored.

Continuing to refer to FIG. 1, in an exemplary embodiment of Step S101, the face or clothing of a person who appears in the video data may be detected to obtain a face or clothing.

Understandably, any implementable graphical detection technology may be used for facial detection and clothing detection; no limitation in this respect is imposed by the present exemplary embodiment.

In one exemplary embodiment of Step S102, the user corresponding to the preset face may be a greeter or may be a staff member. The preset clothing may include the work uniform of a greeter or may also include the work uniform of a staff member. The preset face and the preset clothing may be acquired in advance and may be directly retrieved in the detection process. Specifically, the preset face and the preset clothing may be acquired and stored in advance.

When the face matches the preset face or the clothing matches the preset clothing, then the user corresponding to the face may be a non-customer, i.e. the user in the video data may be a greeter or a staff member. In this situation, the greeter does not need to perform greeting services; therefore, the service quality may not need to be monitored.

When the face does not match the preset face or the clothing does not match the preset clothing, then the user corresponding to the face may be determined to be a customer. In this situation, the greeter may need to perform greeting services; therefore, the service quality may need to be monitored.

After a customer is determined to have been detected, in one exemplary embodiment of Step S103, detection may be performed on the facial expression, movement, and voice of the greeter in the video data. The detection results may include the facial expression, movement, and voice transcript of the greeter.

Specifically, which content from the facial expression, movement, and voice of the greeter is detected may depend on the specific content of the greeting service. For example, when the greeting service includes smiling, bowing, and a verbal greeting, detection may need to be performed simultaneously on the facial expression, movement, and voice of the greeter.

Specifically, a facial expression in the detection results may be matched against a preset facial expression, a movement in the detection results may be matched against a preset movement, and a voice transcript in the detection results may be matched against a preset transcript, and the matching results of the aforementioned matching process may represent the assessment result.

Specifically, the preset facial expression, the preset movement, and the preset transcript may be configured in advance. The preset facial expression, the preset movement, and the preset transcript may be adaptively combined and configured according to the actual application environment. No limitation in this respect may be imposed by the exemplary embodiments of the present disclosure.

In another exemplary application scenario, the standards of service may be configured by checking boxes in advance, including but not limited to: whether the greeter needs to bow, whether the greeter needs to smile, or whether the greeter needs to provide verbal service, etc.

Then, in one exemplary embodiment of Step S104, the service quality of each greeter may be evaluated on the basis of the detection results. In other words, the greater the match between the facial expression and the preset facial expression, the higher the service quality in the assessment result may be; the greater the match between the movement and the preset movement, the higher the service quality in the assessment result may be; and the greater the match between the voice transcript and the preset transcript, the higher the service quality in the assessment result may be.

In another exemplary embodiment of Step S102, when none of the faces detected in the video data match the preset face, a warning message may be issued. In other words, when none of the faces detected in the video data match the preset face, then there may be no greeter in the greeting area, so a warning prompt may need to be sent to relevant personnel for timely response to ensure service quality.

In this exemplary embodiment of the present disclosure, the customer and greeter may be determined on the basis of the face or clothing in the video data, detection may be performed on the facial expression, movement, and/or voice of the greeter when the customer appears, and the service quality of the greeter may be evaluated on the basis of the detection results. This may eliminate the subjectivity and labor costs associated with providing human judgment, achieve accuracy of service quality monitoring, and reduce monitoring costs, thereby increasing monitoring efficiency. Moreover, detection may not be performed on the facial expression, movement, and/or voice of the greeter until a customer has been detected in the video data, preventing ineffective detection when no customer is present and reducing the power consumption of the detection device.

Further, after the assessment result on the service quality of each greeter is acquired, when the assessment result indicates the service quality of the greeter has failed to reach a set standard (for example, the greeter failed to smile when bowing or providing verbal service), the identification of the greeter may be recorded and reported to a server. Specifically, facial recognition may be performed on the greeter to acquire the greeter's work ID, name, etc.

Further still, when the assessment result indicates that the service quality of the greeter has failed to reach the set standard, a warning message may be sent.

In one exemplary embodiment of the present invention, Step S103 illustrated in FIG. 1 may include the following steps:

detecting and acquiring a facial expression of the greeter, matching the facial expression against a preset expression to obtain an expression matching result, and adding the expression matching result to the detection results;

and/or detecting and acquiring a movement performed by the greeter, matching the movement against a preset movement to obtain a movement matching result, and adding the movement matching result to the detection results;

and/or detecting and acquiring a voice transcript of the greeter, matching the voice transcript against a preset transcript to obtain a voice matching result, and adding the voice matching result to the detection results.

In an exemplary embodiment, the detection results may include the expression matching result and/or movement matching result and/or voice matching result.

Specifically, the expression matching result may include two types, i.e. match and no match. The expression matching result may also include three types, i.e. complete match, basic match, and no match. Alternatively, the expression matching result may also be divided into more categories.

Similarly, the movement matching result and the voice matching result may also be divided into more categories.

In one exemplary embodiment, facial recognition technology may be used to perform detection and matching on the facial expression to detect whether the greeter makes the preset facial expression. Human form detection technology may be used to realize movement detection and matching; for example, the position of the greeter's head and shoulders and the angle of bend of the greeter's upper body may be detected to determine whether the greeter performs a bowing movement. Voice detection technology may be used to perform voice detection to determine whether the greeter delivers the preset transcript; for example, the preset transcript may be “welcome.” Further, a large amount of noise may typically be present in application scenarios where greeting services take place. Therefore, noise reduction operations may be further carried out on the acquired voice before voice transcript recognition is performed to increase recognition efficiency and accuracy.

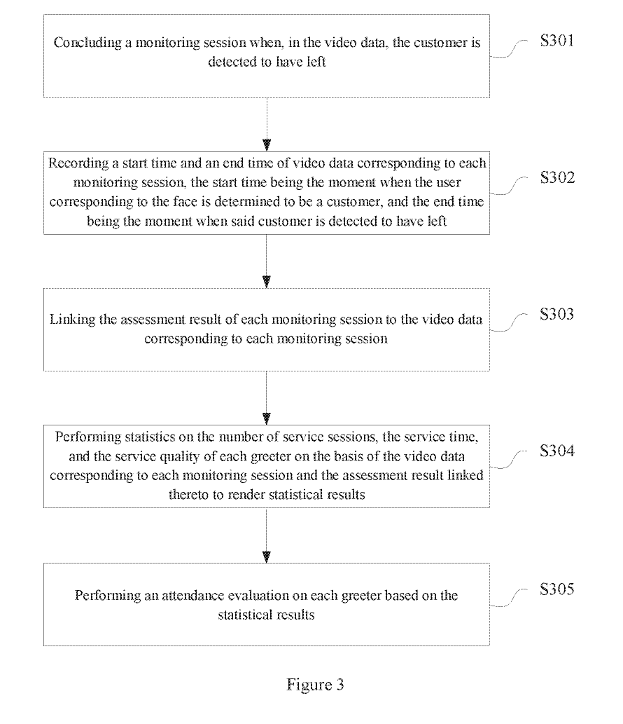

In another preferred exemplary embodiment of the present disclosure, referring to FIG. 3, the video processing method may further include the following steps:

Step S301: concluding a monitoring session when, in the video data, the customer is detected to have left.

In an exemplary embodiment, the customer may be detected to have left refers to the detection of the customer leaving the video scene.

From the customer's entry into the greeting area to the customer's leaving of the greeting area, the greeter may need to perform one complete session of greeting service. Thus, one complete monitoring session may be regarded as beginning with the detection of a customer and ending with the customer leaving the video scene in the video data. During the monitoring session, the greeter's service quality may need to be monitored; when no customer is present in the video data, the greeter's service quality may not need to be monitored.

By eliminating the need to monitor the entirety of the video data, this exemplary embodiment of the present disclosure may increase monitoring efficiency while ensuring monitoring accuracy.

Step S302 may include recording the start time and end time of video data corresponding to each monitoring session, the start time being the moment when the user corresponding to the face is determined to be a customer, and the end time being the moment when the customer is detected to have left;

Step S303 may include linking the assessment result of each monitoring session to the video data corresponding to each monitoring session.

In the present exemplary embodiment, after one monitoring session is determined, the monitoring session may be linked to its corresponding video data. Then, the assessment result obtained from this monitoring session may be linked to the video data corresponding to this monitoring session.

By determining and recording the start time and end time of each monitoring session and then linking its corresponding video data to its corresponding assessment result, traceability and verifiability of the assessment result may be achieved, thereby improving user experience.

For example, the start time of a monitoring session may be 13:00 Jan. 22, 2018, the end time may be 13:05 Jan. 22, 2018, and the assessment result for the monitoring session may be relatively poor service quality. Thus, when a user needs to verify this service session, the corresponding video data may be retrieved on the basis of the recorded start time and the recorded end time. This eliminates the need for a user to search through large volumes of video data, reduces time costs and labor costs, and improves monitoring efficiency.

Step S304 may include performing statistics on the number of service sessions, the service time, and the service quality of each greeter on the basis of the video data corresponding to each monitoring session and the assessment result linked thereto to render statistical results; and

Step S305 may include performing an attendance evaluation on each greeter on the basis of said statistical results.

In the present exemplary embodiment, after the video data corresponding to each monitoring session has been determined, statistics may be performed on the number of service sessions and the service time of each greeter on the basis of the video data corresponding to each monitoring session; statistics may be performed on the service quality of each greeter on the basis of the assessment result linked to the video data.

Specifically, video data covering a certain interval of time may be divided into a plurality of video data subsets according to the start times and end times of the monitoring sessions. The number of service sessions may be the number of video data subsets in which the greeter appears. The service time may be the total duration of video data subsets in which the greeter appears. The service quality may be an evaluation of all the assessment results of the greeter.

Thus, in one exemplary embodiment of Step S305, the attendance results for each greeter may be evaluated using the statistical results (for example, whether the number of service sessions of the greeter reaches a preset number, whether the service time of the greeter reaches a preset duration, whether the service quality of the greeter reaches a particular standard, etc.).

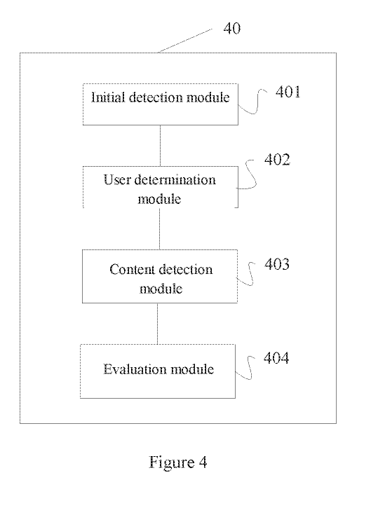

Referring to FIG. 4, one exemplary embodiment of the present disclosure may further disclose a device 40 for processing video data.

The device 40 may include an initial detection module 401, a user determination module 402, a content detection module 403, and an evaluation module 404.

Here, the initial detection module 401 may be adapted to perform facial detection or clothing detection on acquired video data to obtain a face or clothing;

the user determination module 402 may be adapted to, when the face does not match a preset face or the clothing does not match a preset clothing, determine the user corresponding to the face to be a customer, the user corresponding to the preset face including a greeter;

the content detection module 403 may be adapted to perform facial expression detection, movement detection, and/or voice detection on a greeter in the video data to obtain detection results; and

the evaluation module 404 may be adapted to evaluate service quality on the basis of the detection results to obtain an assessment result.

In this exemplary embodiment, the customer and greeter may be determined on the basis of the face or clothing in the video data, detection may be performed on the facial expression, movement, and/or voice of the greeter when the customer appears, and the service quality of the greeter may be evaluated on the basis of the detection results. This may eliminate the subjectivity and labor costs associated with providing human judgment, achieve accuracy of service quality monitoring, and reduce monitoring costs, thereby increasing monitoring efficiency. Moreover, detection may not be performed on the facial expression, movement, and/or voice of the greeter until a customer has been detected in the video data, preventing ineffective detection when no customer is present and reducing the power consumption of the detection device.

In one exemplary embodiment of the present disclosure, the content detection module 403 may include: a facial expression detection unit (not shown in the figure), which may be adapted to detect and acquire a facial expression of the greeter, match the facial expression against a preset expression to obtain an expression matching result, and add the expression matching result to the detection results;

a movement performance detection unit (not shown in the figure), which may be adapted to detect and acquire a movement performed by the greeter, match the movement against a preset movement to obtain a movement matching result, and add the movement matching result to the detection results; and

a voice detection unit (not shown in the figure), which may be adapted to detect and acquire a voice transcript of the greeter, match the voice transcript against a preset transcript to obtain a voice matching result, and add the voice matching result to the detection results.

In one preferred exemplary embodiment of the present disclosure, the evaluation module 404 may include a service quality evaluation unit (not shown in the figure), which may be adapted to, on the basis of the expression matching result, the movement matching result, and/or the voice matching result in the detection results of each greeter, determine the service quality of each greeter and add the service quality to the assessment result.

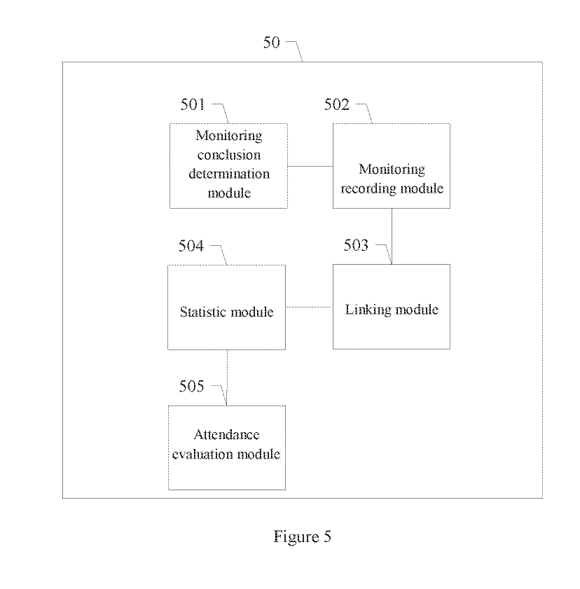

In another preferred exemplary embodiment of the present disclosure, referring to FIG. 5, a device 50 for processing video data may include a monitoring conclusion determination module 501, which may be adapted to conclude a monitoring session when, in the video data, the customer is detected to have left.

a monitoring recording module 502, which may be adapted to record the start time and end time of video data corresponding to each monitoring session, the start time being the moment when the user corresponding to the face is determined to be a customer, and the end time being the moment when the customer is detected to have left;

a linking module 503, which may be adapted to link the assessment result of each monitoring session to the video data corresponding to each monitoring session.

By determining and recording the start time and end time of each monitoring session and then linking its corresponding video data to its corresponding assessment result, this exemplary embodiment of the present disclosure may achieve traceability and verifiability of the assessment result, thereby improving user experience.

A statistic module 504 may be adapted to perform statistics on the number of service sessions, the service time, and the service quality of each greeter on the basis of the video data corresponding to each monitoring session and the assessment result linked thereto to render statistical results; and an attendance evaluation module 505 may be adapted to perform an attendance evaluation on each greeter on the basis of the statistical results.

This exemplary embodiment of the present disclosure may further perform an attendance evaluation on a greeter using video data corresponding to the monitoring sessions, i.e. a service quality evaluation and an attendance evaluation are simultaneously achieved to increase monitoring efficiency.

One exemplary embodiment of the present disclosure may further disclose a non-transitory computer-readable medium comprising instructions that, when executed by a processor, cause the processor to perform the steps of the aforementioned method of processing video data illustrated in FIG. 1 and/or FIG. 3. The non-transitory computer-readable medium may include a ROM, a RAM, a magnetic disk, or an optical disc, etc. The non-transitory computer-readable medium may further include a non-volatile storage device or a non-transitory storage device, etc.

According to another exemplary embodiment of the present disclosure, a controller or terminal 60 may be provided. The controller or terminal 60 may include, but is not limited to, a cell phone, a computer, a tablet, or another terminal device.

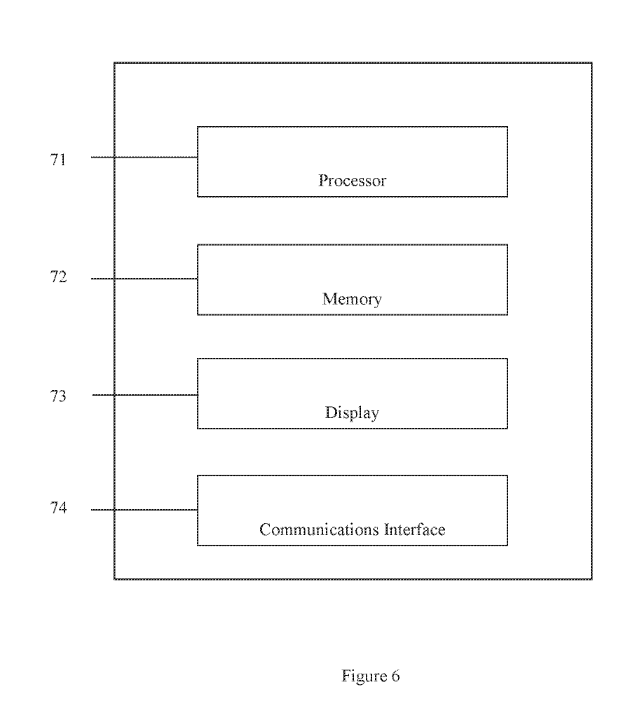

Referring to FIG. 6, a controller or terminal 60 may include a memory 62 storing instructions that, when executed by a processor 61, cause the processor 61 to perform the steps of monitoring service quality illustrated in FIGS. 1 and/or 3. The arrangement and number of components in controller or terminal 60 are provided for purposes of illustration. Additional arrangement, number of components, and other modifications may be made, consistent with the present disclosure. In some embodiments, the controller or terminal 60 may be a server or a workstation; it may also be a smartphone, a tablet, or another terminal device.

Controller or terminal 60 may also include one or more input/output (I/O) devices (not shown). By way of example, I/O devices may include physical keyboard, virtual touch-screen keyboard, mice, joysticks, styluses, etc. In certain exemplary embodiments, I/O devices may include a microphone (not shown) for providing input to controller or terminal 60 using, for example, voice recognition, speech-to-text, and/or voice command applications. In other exemplary embodiments, I/O devices may include a keypad and/or a keypad on a touch-screen for providing input to controller or terminal 60.

Controller or terminal 60 may also include one or more displays 63 for displaying data and information. Display 63 may be implemented using devices or technology, such as a cathode ray tube (CRT) display, a liquid crystal display (LCD), a plasma display, a light emitting diode (LED) display, a touch screen type display, a projection system, and/or any other type of display.

Controller or terminal 60 may further include one or more communications interface 76. Communications interface 64 may allow software and/or data to be transferred between controller or terminal 60 and other remote devices or the cloud server. Examples of communications interface 64 may include a modem, network interface (e.g., an Ethernet card or a wireless network card), a communications port, a PCMCIA slot and card, a cellular network card, etc. Communications interface 74 may transfer software and/or data in the form of signals, which may be electronic, electromagnetic, optical, or other signals capable of being transmitted and received by communications interface 64. Communications interface 64 may transmit or receive these signals using wire, cable, fiber optics, radio frequency (“RF”) link, Bluetooth link, and/or other communications channels.

Notwithstanding the above disclosure, the exemplary embodiments of the present disclosure is not limited thereby. Any person having ordinary skill in the art may make various alterations and changes that are not detached from the essence and scope of the exemplary embodiments of the present disclosure. Therefore, the scope of protection for the exemplary embodiments of the present disclosure should be that as defined by the claims.

What is claimed is:

1. A method, comprising:
recognizing at least one of a face or a piece of clothing from video data representing a scene;
when the recognized face does not match a preset face or the recognized clothing does not match preset clothing, determining a user corresponding to the recognized face or recognized clothing to be a customer, the preset face or preset clothing corresponding to a greeter in the scene;
performing a detection of at least one of facial expression, movement, or voice of the greeter from the video data, to generate a detection result; and
determining a service quality of the greeter based on the detection result, to generate an assessment result.

2. The method of claim 1, wherein performing the detection of at least one of facial expression, movement, or voice of the greeter from the video data, to generate the detection result, further comprises at least one of:
detecting and acquiring a facial expression of the greeter, matching the facial expression of the greeter against one or more preset facial expressions to obtain an expression matching result, and adding the expression matching result to the detection result;
detecting and acquiring a movement performed by the greeter, matching the movement of the greeter against one or more preset movements to obtain a movement matching result, and adding the movement matching result to the detection result; or
detecting and acquiring a voice transcript of the greeter, matching the voice transcript against one or more preset transcripts to obtain a voice matching result, and adding the voice matching result to the detection result.

3. The method of claim 2, wherein determining the service quality based on the detection result, to generate an assessment result, further comprises:
determining the service quality of the greeter based on at least one of the expression matching result, the movement matching result, or the voice matching result, and adding the service quality to the assessment result.

4. The method of claim 1, further comprising:
determining, based on the video data, whether the customer has left the scene; and
in response to the determination that the customer has left the scene, ending a monitoring session of the scene.

5. The method of claim 4, further comprising:
recording a start time and an end time for video data corresponding to the monitoring session, the start time being a point in time when a customer is determined in the scene, and the end time being a point in time when the customer is determined to have left the scene; and
linking the assessment result to the video data corresponding to the monitoring session.

6. The method of claim 5, further comprising:
determining a plurality of monitoring sessions;
performing a statistical analysis on a number of service sessions, service durations, and service qualities of the greeter based on video data corresponding to the plurality of monitoring sessions respectively and assessment results linked thereto, to generate a statistical result for the greeter; and
performing an attendance evaluation on the greeter based on the statistical result.

7. A device for processing video data, comprising:
a memory storing instructions; and
a processor configured to execute the instructions to:
recognize at least one of a face or a piece of clothing from video data representing a scene;
when the recognized face does not match a preset face or the recognized clothing does not match preset clothing, determine a user corresponding to the recognized face or recognized clothing to be a customer, the preset face or preset clothing corresponding to a greeter in the scene;
perform a detection of at least one of facial expression, movement, or voice of the greeter from the video data, to generate a detection result; and
determine a service quality of the greeter based on the detection result, to generate an assessment result.

8. The device of claim 7, wherein the processor is further configured to execute the instructions to:
detect and acquire a facial expression of the greeter, match the facial expression of the greeter against one or more preset facial expressions to obtain an expression matching result, and add the expression matching result to the detection result;
detect and acquire a movement performed by the greeter, match the movement of the greeter against one or more preset movements to obtain a movement matching result, and add the movement matching result to the detection result; and
detect and acquire a voice transcript of the greeter, match the voice transcript against one or more preset transcripts to obtain a voice matching result, and add the voice matching result to the detection result.

9. The device of claim 8, wherein the processor is further configured to execute the instructions to:
determine the service quality of the greeter based on at least one of the expression matching result, the movement matching result, or the voice matching result, and add the service quality to the assessment result.

10. The device of claim 7, wherein the processor is further configured to execute the instructions to:
determine, based on the video data, whether the customer has left the scene; and
in response to the determination that the customer has left the scene, end a monitoring session of the scene.

11. The device of claim 10, wherein the processor is further configured to execute the instructions to
record a start time and an end time for video data corresponding to the monitoring session, the start time being a point in time when a customer is determined in the scene, and the end time being a point in time when the customer is determined to have left the scene; and
link the assessment result to the video data corresponding to the monitoring session.

12. The device of claim 11, wherein the processor is further configured to execute the instructions to:
determine a plurality of monitoring sessions;
perform a statistical analysis on a number of service sessions, service durations, and service qualities of the greeter based on video data corresponding to the plurality of monitoring sessions respectively and assessment results linked thereto, to generate a statistical result for the greeter; and
perform an attendance evaluation on the greeter based on the statistical result.

13. A non-transitory computer-readable medium comprising instructions that, when executed by a processor, cause the processor to:
recognize at least one of a face or a piece of clothing from video data representing a scene;
when the recognized face does not match a preset face or the recognized clothing does not match preset clothing, determine a user corresponding to the recognized face or recognized clothing to be a customer, the preset face or preset clothing corresponding to a greeter in the scene;
perform a detection of at least one of facial expression, movement, or voice of the greeter from the video data, to generate a detection result; and
determine a service quality of the greeter based on the detection result, to generate an assessment result.

14. The non-transitory computer-readable medium of claim 13, wherein the instructions further cause the processor to perform at least one of:
detecting and acquiring a facial expression of the greeter, matching the facial expression of the greeter against one or more preset facial expressions to obtain an expression matching result, and adding the expression matching result to the detection result;
detecting and acquiring a movement performed by the greeter, matching the movement of the greeter against one or more preset movements to obtain a movement matching result, and adding the movement matching result to the detection result; or
detecting and acquiring a voice transcript of the greeter, matching the voice transcript of the greeter against one or more preset transcripts to obtain a voice matching result, and adding the voice matching result to the detection result.

15. The non-transitory computer-readable medium of claim 14, wherein the instructions further cause the processor to:
determine the service quality of the greeter based on at least one of the expression matching result, the movement matching result, or the voice matching result, and adding the service quality to the assessment result.

16. The non-transitory computer-readable medium of claim 13, wherein the instructions further cause the processor to:
determine, based on the video data, whether the customer has left the scene; and
in response to the determination that the customer has left the scene, end a monitoring session of the scene.

17. The non-transitory computer-readable medium of claim 16, wherein the instructions further cause the processor to:
record a start time and an end time for video data corresponding to the monitoring session, the start time being a point in time when a customer is determined in the scene, and the end time being a point in time when the customer is determined to have left the scene; and
link the assessment result to the video data corresponding to the monitoring session.

18. The non-transitory computer-readable medium of claim 17, wherein the instructions further cause the processor to:
determine a plurality of monitoring sessions;
perform a statistical analysis on a number of service sessions, service durations, and service qualities of the greeter based on video data corresponding to the plurality of monitoring sessions respectively and assessment results linked thereto, to generate a statistical result for the greeter; and
perform an attendance evaluation on the greeter based on the statistical result.
